(19) United States
(12) Patent Application Publication
(10) Pub. No.: US 2021/0332896 A1
(43) Pub. Date: Oct. 28, 2021

(54) WATER VALVE

(71) Applicant: SHIN TAI SPURT WATER OF THE GARDEN TOOLS CO., LTD, Lu-Kang Town (TW)

(72) Inventor: Chin-Yuan Chen, LU-KANG TOWN (TW)

(21) Appl. No.: 16/858,696

(22) Filed: Apr. 26, 2020

(51) Int. Cl. F16K 11/20; F16K 3/26; F16K 11/22

(52) U.S. Cl. CPC F16K 11/207; F16K 11/22; F16K 11/202; F16K 3/26

(57) ABSTRACT

A water valve has a horizontal tubular main body and two control valves. The main body has an inlet opening with an exit opening at each of two sides, the main body is provided with two internal ring lips for defining an intake channel sandwiched by two exiting channels, the two exiting channels respectively configured to be connected to the two control valves, Each control valve has a fixed valve tube secured in the respective exiting channel, the fixed valve tube has a through hole facing the exit opening, the fixed valve tube is inserted with a moveable axis, the moveable axis is hollow and has one open end and a closed end, a handle is connected to the moveable axis extending from the fixed valve tube and the closed end of the main body.

### BACKGROUND OF INVENTION

### Field of Invention

The present invention relates to a water valve, and more particularly to a water valve capable of separately providing four water outputs.

### Description of the Related Art

In order to avoid plants drying up and dying due to lack of water, watering routine is a very frequent and important gardening work. Usually the plants are planted in a wide range or a certain distance from the water source, therefore, the water hose extension is employed and connected to the water via a connector, then the water hose is connected to the sprinkler device. However, it is impossible to achieve the effect of diverting and separately controlling the opening and closing for multiple water hose or sprinkler device. Therefore, when there are many places that need to be watered, it is necessary to find more water sources or to water different places alternatively, which is not convenient in use.

Therefore, it is desirable to provide a faucet aerator capable to mitigate and/or obviate the aforementioned problems.

### SUMMARY OF THE INVENTION

An objective of present invention is to provide a water valve, which is capable of improving the above-mention problems.

In order to achieve the above mentioned objective, a water valve has a horizontal tubular main body and two control valves.

The main body has an inlet opening with an exit opening at each of two sides, the main body is provided with two internal ring lips for defining an intake channel sandwiched by two exiting channels, the two exiting channels respectively configured to be connected to the two control valves, and the exit openings provided with an intake fitting extending from the main body. Each control valve has a fixed valve tube secured in the respective exiting channel, the fixed valve tube has a through hole facing the exit opening, the fixed valve tube is inserted with a moveable axis, the moveable axis is hollow and has one open end and a closed end, and a handle is connected to the moveable axis extending from the fixed valve tube and the closed end of the main body.

Other objects, advantages, and novel features of invention will become more apparent from the following detailed description when taken in conjunction with the companying drawings.

### BRIEF DESCRIPTION OF DRAWINGS

FIG. 1 is a three-dimensional combination drawing of a preferred embodiment according to the present invention.

FIG. 2 is a three-dimensional exploded view of the preferred embodiment according to the present invention.

FIG. 3 is a detailed drawing of the control valve of the preferred embodiment according to the present invention.

FIG. 4 is cross-sectional drawing showing the two control valves being opened in the preferred embodiment according to the present invention.

FIG. 5 is cross-sectional view along the line A-A in FIG. 4.

FIG. 6 is the schematic drawing and a cross-sectional drawing along the line B-B in FIG. 4 when shutting down the water.

FIG. 7 is a state drawing when the valve is closed.

FIG. 8 is a state drawing showing one of the control valves being open and one of control valves is closed in the preferred embodiment according to the present invention.

FIG. 9 a state drawing showing one of the control valves being closed at the same time in the preferred embodiment according to the present invention.

### DETAILED DESCRIPTION OF THE PREFERRED EMBODIMENT

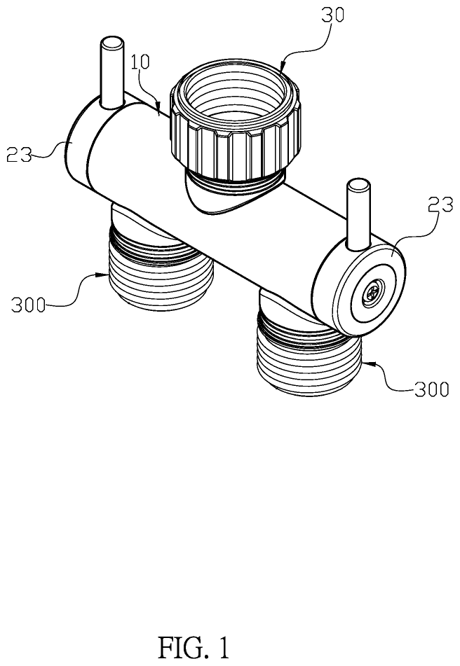

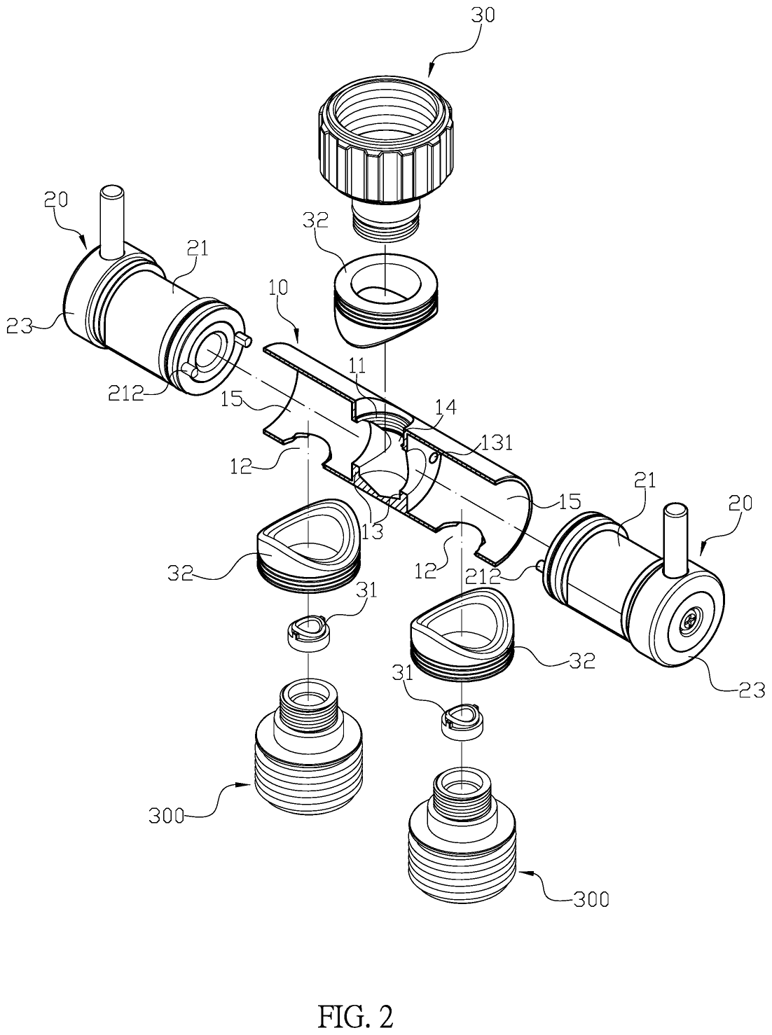

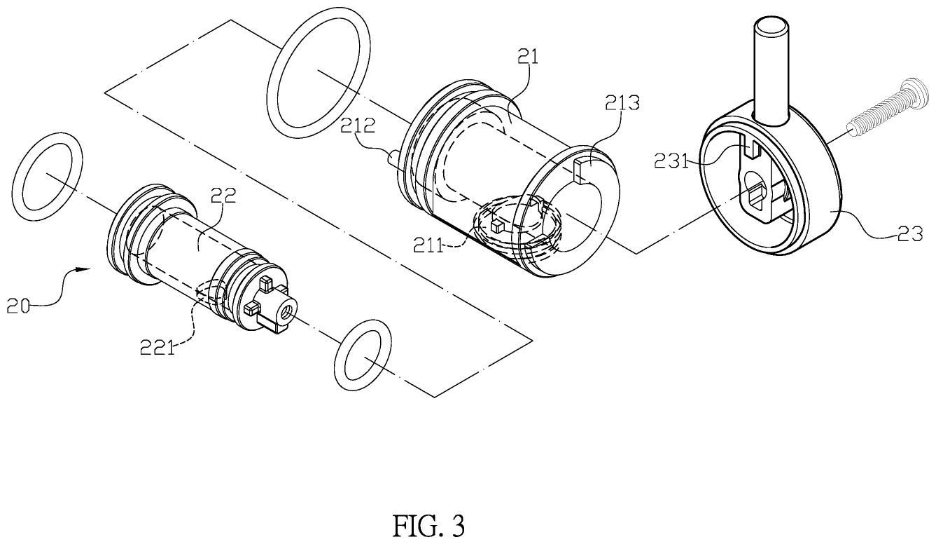

First, please refer to FIG. 1 to FIG. 4. A water valve comprises a horizontal tubular main body 10 and two control valves 20. The main body 10 has an inlet opening 11 with an exit opening 12 at each of two sides. The main body 10 is provided with two internal ring lips 13 for defining an intake channel 14 sandwiched by two exiting channels 15. The two exiting channels 15 are respectively configured to be connected to the two control valves 20. With the connection of the inlet opening 11, the intake channel 14, the exiting channel 15 and the exit opening 12, the water enters through the inlet opening 11 into the main body 10 and the intake channel 14 and divides into the two exiting channels 15, then exits from the exit opening 12. Each exit opening 12 is provided with an intake fitting 30 extending from the main body 10. The control valve 20 has a fixed valve tube 21 secured in the respective exiting channel 15, the fixed valve tube 21 has a through hole 211 facing the exit opening 12. The fixed valve tube 21 is inserted with a moveable axis 22, and the moveable axis 22 is hollow and has one open end and a closed end. A handle 23 is connected to the moveable axis 22 extending from the fixed valve tube 21 and the closed end of the main body 10. When the handle 23 is turned, the handle 23 moves a through aperture 221 located on the moveable axis 22 to align with or offset from the through hole 211, and the through hole 211 of the fixed valve tube 21 is further provided with an outlet fitting 300 extending from the main body 10.

Moreover, the main body 10, the handle 23, the intake fitting 30 and the outlet fitting 300 are all made of metal.

Furthermore, the main body 10, the intake fitting 30 and the outlet fitting 300 are made from copper pipe or a copper ingot.

In addition, the ring lip 13 of the main body 10 is further provided with a positioning aperture 131, and the fixed valve tube 21 further has an extending positioning foot 212 configured for insertion into the positioning aperture 131.

Moreover, the fixed valve tube 21 and the moveable axis 22 are engaged with a corresponding positioning rib and positioning groove for secure engagement.

Additionally, the fixed valve tube 21 and the moveable axis 22 both are respectively jacketed with a sealing ring.

Moreover, a corresponding face of the fixed valve tube 21 and a corresponding face of the handle 23 respectively have a positioning flange 213 and a positioning pin 231.

Furthermore, the intake fitting 30 and the outlet fitting 300 are screwed together for assembly.

Moreover, the outlet fitting 300 is further provided with an inner leak-proof pad 31.

In addition, the intake fitting 30 and the outlet fitting 300 is further provided with an outer leak-proof pad 32.

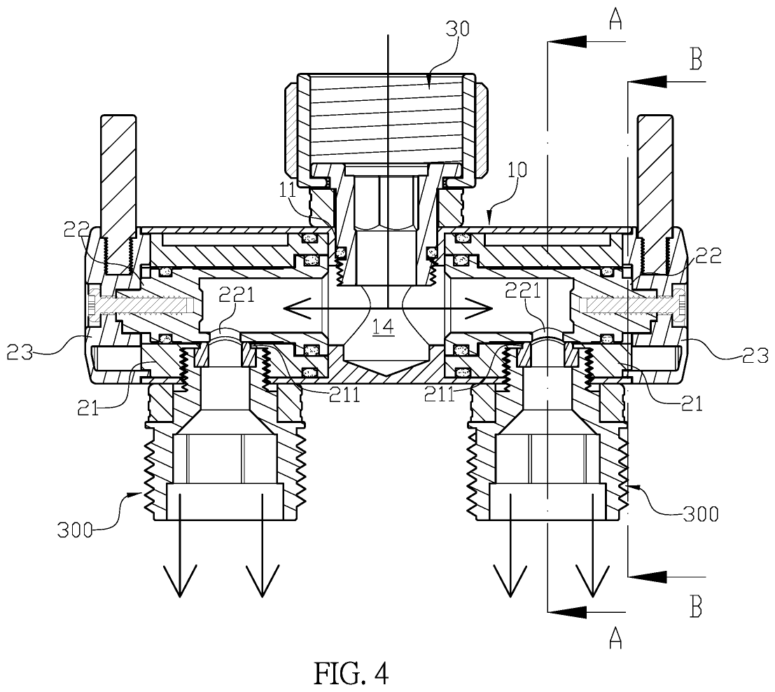

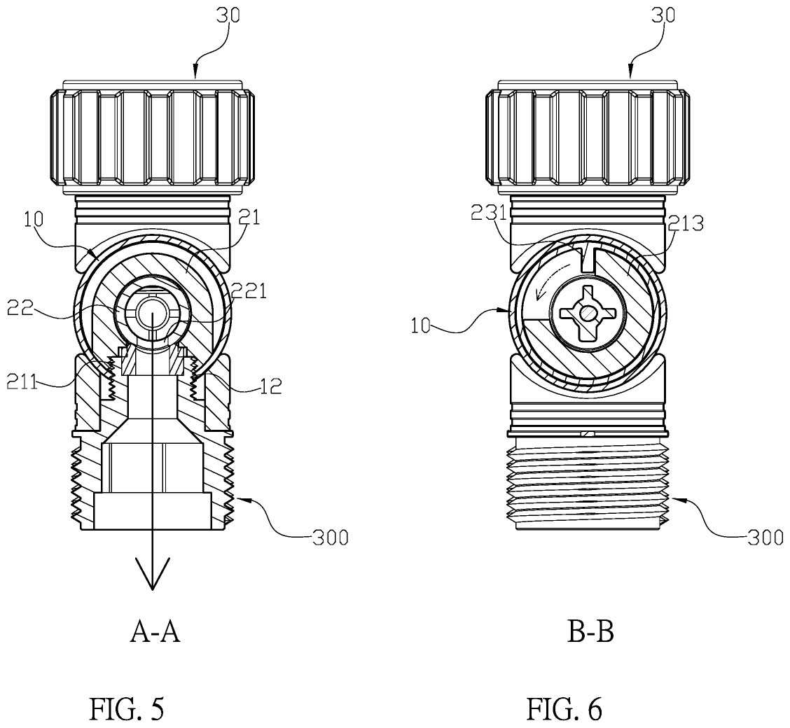

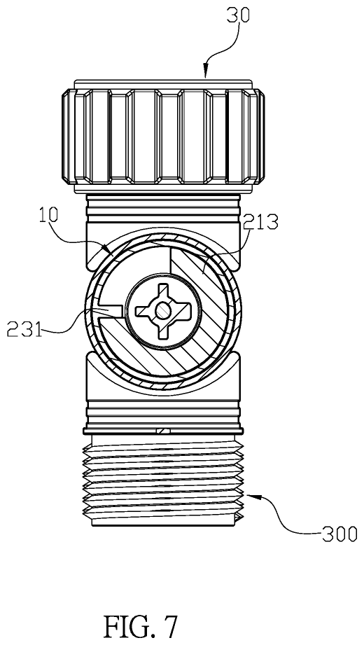

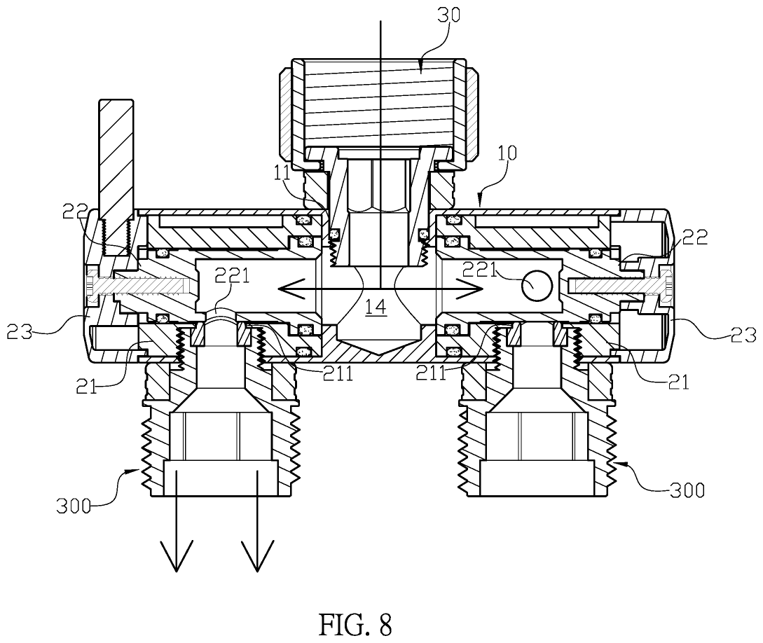

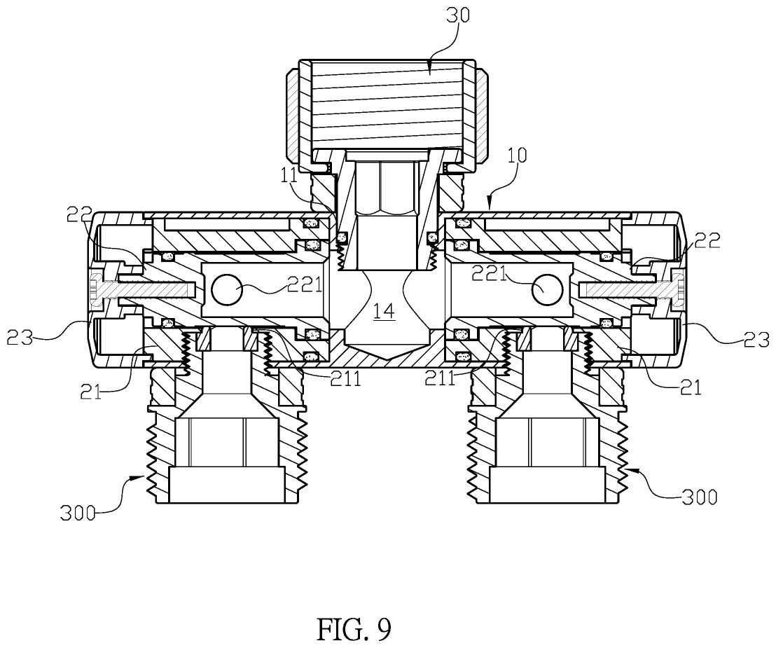

In actual use, the intake fitting 30 is connected to a water source through a water host, and the outlet fitting 300 is connected to the water sprinkler device through the water host, so that the same water source can be used for two sprinklers at different locations at the same time. The separate or simultaneous operation of the two handles 23 also enables two control valves 20 to be opened simultaneously (as shown in FIGS. 4 and 5), one open and one closed at the same time (as shown in FIG. 8) or closed at the same time (as shown in FIG. 9) base on the needs of use. Through the control valve 20, (as shown in FIGS. 6 and 7) there is no need go to the water source to open and close the water output, which achieves the best convenience in use.

Although the present invention has been explained in relation to its preferred embodiment, it is to be understood that many other possible modifications and variations can be made without departing from the spirit and scope of invention as hereinafter claimed.

What is claimed is:

1. A water valve comprising: a horizontal tubular main body and two control valves; wherein:
the main body has an inlet opening with an exit opening at each of two sides, the main body is provided with two internal ring lips for defining an intake channel sandwiched by two exiting channels, the two exiting channels respectively configured to be connected to the two control valves, the exit openings provided with an intake fitting extending from the main body; and
each control valve has a fixed valve tube secured in the respective exiting channel, the fixed valve tube has a through hole facing the exit opening, the fixed valve tube is inserted with a moveable axis, the moveable axis is hollow and has one open end and a closed end, a handle is connected to the moveable axis extending from the fixed valve tube and the closed end of the main body; wherein when the handle is turned, the handle moves a through aperture located on the moveable axis to align with or offset from the through hole, and the through hole of the fixed valve tube is further provided with an outlet fitting extending from the main body.

2. The water valve as claimed in claim 1, wherein the main body, the handle, the intake fitting and the outlet fitting are all made of metal.

3. The water valve as claimed in claim 2, wherein the main body, the intake fitting and the outlet fitting are made from copper pipe or a copper ingot.

4. The water valve as claimed in claim 1, wherein the ring lip of the main body is further provided with a positioning aperture, and the fixed valve tube further has an extending positioning foot configured for insertion into the positioning aperture.

5. The water valve as claimed in claim 1, wherein the fixed valve tube and the moveable axis are engaged with a corresponding positioning rib and positioning groove.

6. The water valve as claimed in claim 1, wherein the fixed valve tube and the moveable axis both are respectively jacketed with a sealing ring.

7. The water valve as claimed in claim 1, wherein a corresponding face of the fixed valve tube and a corresponding face of the handle respectively have a positioning flange and a positioning pin.

8. The water valve as claimed in claim 1, wherein the intake fitting and the outlet fitting are screwed together for assembly.

9. The water valve as claimed in claim 1, wherein the outlet fitting is further provided with an inner leak-proof pad.

10. The water valve as claimed in claim 1, wherein the intake fitting and the outlet fitting is further provided with an outer leak-proof pad.
